(19) United States
(12) Patent Application Publication
(10) Pub. No.: US 2024/0295708 A1
(43) Pub. Date: Sep. 5, 2024

(54) OPTICAL DEVICE, OPTICAL TRANSMISSION DEVICE, AND OPTICAL RECEPTION DEVICE

(71) Applicant: FUJITSU OPTICAL COMPONENTS LIMITED, Kawasaki-shi (JP)

(72) Inventor: Masaki SUGIYAMA, Kawasaki (JP)

(73) Assignee: FUJITSU OPTICAL COMPONENTS LIMITED, Kawasaki-shi (JP)

(21) Appl. No.: 18/425,106

(22) Filed: Jan. 29, 2024

(30) Foreign Application Priority Data
Mar. 1, 2023 (JP) 2023-031286

(51) Int. Cl. G02B 6/42

(52) U.S. Cl. CPC G02B 6/4239; G02B 6/4206

(57) ABSTRACT

An optical device includes a substrate, a trench that is formed on the substrate, an optical waveguide that is formed on the substrate and that is connected to a first side surface of the trench, and a lens that is arranged on the first side surface included in the trench and that is connected to the optical waveguide. Furthermore, the optical device includes an optical fiber that is secured, by an adhesive, to a chip end surface that is located adjacent to a second side surface that is located opposite the first side surface included in the trench.

### CROSS-REFERENCE TO RELATED APPLICATION

This application is based upon and claims the benefit of priority of the prior Japanese Patent Application No. 2023-031286, filed on Mar. 1, 2023, the entire contents of which are incorporated herein by reference.

### FIELD

The embodiments discussed herein are related to an optical device, an optical transmission device, and an optical reception device.

### BACKGROUND

In recent years, there are increased demands for optical fiber communication in accordance with an increase in communication capacity. In optical fiber communication, there is a need to use an optical device that converts an electrical signal used by, for example, a computer to an optical signal used for transmission passing through an optical fiber. There is a demand for an optical device with a small-size, low-power, and large-capacity type in response to market demand, and, to implement this, silicon photonics (SiPh) device in which a waveguide and an electrode substrate are integrally mounted on a Si substrate attracts a great deal of attention, and research and development are actively conducted on a daily basis. A great advantage of SiPh is that it is possible to easily manufacture a large scale optical integrated circuit that is constituted by a lot of element devices by making use of high-definition process technology that is used to manufacture CMOS.

To mount such a Photonics Integrated Circuit (PIC) as a module that is used for optical communication, there is a need to route a Si waveguide in the PIC up to a chip end surface, and there is a need to input and output light by optically connecting the Si waveguide and the optical fiber. Therefore, a low coupling loss and long-term reliability are needed for the connection between the Si waveguide and the optical fiber.

FIG. 25 is a schematic plan view illustrating one example of an optical device 100 that is conventionally used, and FIG. 26 is a schematic cross-sectional view taken along line J-J illustrated FIG. 25. The optical device 100 is an edge coupler that includes an optical IC chip 110 and an optical fiber 120 and in which the optical fiber 120 is mounted on the optical IC chip 110. The optical IC chip 110 includes a Si substrate 111, a first clad layer 112A that is made of SiO₂ and that is laminated on the Si substrate 111, and a Si waveguide 113 that is laminated on the first clad layer 112A. The optical IC chip 110 includes a second clad layer 112B that is made of SiO₂ and that is laminated on the first clad layer 112A and the Si waveguide 113. A clad layer 112 is formed by the first clad layer 112A and the second clad layer 112B.

The Si waveguide 113 includes a straight line waveguide 113A and a tapered waveguide 113B. The straight line waveguide 113A is an optical waveguide having a shape of a straight line. The tapered waveguide 113B is an optical waveguide having a tapered shape that is constituted such that the waveguide width of the tapered waveguide 113B is gradually narrower from the straight line waveguide 113A toward a chip end surface 114 viewed from the top.

The optical fiber 120 includes a core 121, and is constituted such that the leading end of the optical fiber 120 is used as a bonding surface 122. Then, at the chip end surface 114 of the optical IC chip 110, a portion between the core 121 that is included in the optical fiber 120 and that is located at the bonding surface 122 and the end surface of the Si waveguide 113 is optically coupled by using an adhesive 130. In the edge coupler, it is possible to increase a an mode field of light by reducing a waveguide width of the Si waveguide 113 at the chip end surface 114 that is coupled to the optical fiber 120, so that it is possible to reduce a coupling loss between the Si waveguide 113 and the optical fiber 120.

When the optical fiber 120 is mounted on the chip end surface 114 of the optical IC chip 110, the adhesive 130 is applied to the chip end surface 114, the optical fiber 120 is in alignment with the Si waveguide 113, and then, the optical fiber 120 is secured to the optical IC chip 110 by hardening the adhesive 130.

However, even if the waveguide width of the Si waveguide 113 included in the edge coupler is reduced, the mode field of the Si waveguide 113 is smaller than the mode field of the optical fiber 120. Therefore, a coupling loss occurs between the Si waveguide 113 and the core 121 of the optical fiber 120 due to a mismatch between the mode fields.

Accordingly, in order to reduce the coupling loss between the Si waveguide and the core of the optical fiber, there is a known optical device in which a lens is arranged between the Si waveguide and the optical fiber. FIG. 27 is a schematic plan view illustrating one example of an optical device 200 that is conventionally used, and FIG. 28 is a schematic cross-sectional view taken along line K-K illustrated in FIG. 27. The optical device 200 is an edge coupler that includes an optical IC chip 210 and an optical fiber 220 and in which the optical fiber 220 is mounted on the optical IC chip 210.

The optical IC chip 210 includes a Si substrate 211, a first clad layer 212A, a Si waveguide 213, and a second clad layer 212B. A clad layer 212 is formed by the first clad layer 212A and the second clad layer 212B. The Si waveguide 213 includes a straight line waveguide 213A and a tapered waveguide 213B. The straight line waveguide 213A is an optical waveguide having a straight line shape. The tapered waveguide 213B is an optical waveguide that is constituted such that the waveguide width of the tapered waveguide 213B is gradually narrow from the straight line waveguide 213A toward a chip end surface 214. A lens 215 is arranged at the chip end surface 214 of the Si waveguide 213. As a method of arranging the lens 215 on the chip end surface 114, a photosensitive resist is applied to the chip end surface 114, and the lens 215 is formed by using a 3D printer. The optical fiber 220 includes a core 221, and is constituted such that the leading end of the optical fiber 220 is used as a bonding surface 222.

The optical device 200 is able to suppress the coupling loss by matching the mode field of the Si waveguide 213 and the mode field of a core 221 of the optical fiber 220 by using the lens 215.
Patent Document 1: Japanese Laid-open Patent Publication No. 2020-173408
Patent Document 2: Japanese Laid-open Patent Publication No. 2015-22224
Patent Document 3: U.S. Patent Application Publication No. 2016/0246004

However, in the optical device 200, the lens 215 is arranged on the chip end surface 214 of the Si waveguide 213, so that the optical fiber 220 needs to be mounted by being separated from the chip end surface 214. Therefore, there is a need to use a mechanism for securing the optical fiber 220 on a sub-mount, so that the number of man-hours needed for the mounting process is increased as compared to the optical device 100 that is conventionally used.

Accordingly, in order to cope with the circumstances, there is a demand for an optical device capable of reducing the number of mounting man-hours needed for the mounting process when the optical fiber 220 is mounted on the optical IC chip 210 while suppressing the coupling loss between the Si waveguide 213 and the optical fiber 220.

### SUMMARY

According to an aspect of an embodiment, an optical device includes a substrate, a trench that is formed on the substrate, an optical waveguide, a lens and an optical fiber. The optical waveguide is formed on the substrate and is connected to a first side surface of the trench. The lens is arranged on the first side surface included in the trench and is connected to the optical waveguide. The optical fiber is secured, by an adhesive, to a chip end surface that is located adjacent to a second side surface that is located opposite the first side surface included in the trench.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic plan view illustrating one example of an optical device according to a first embodiment;

FIG. 2 is a schematic cross-sectional view taken along line A-A illustrated in FIG. 1;

FIG. 3 is a schematic plan view illustrating one example of an optical device according to a second embodiment;

FIG. 4 is a schematic cross-sectional view taken along line B-B illustrated in FIG. 3;

FIG. 5 is a diagram illustrating one example of reflected light generated in the optical device;

FIG. 6 is a schematic plan view illustrating one example of an optical device according to a third embodiment;

FIG. 7 is a schematic cross-sectional view taken along line C-C illustrated in FIG. 6;

FIG. 8 is a diagram illustrating one example of reflected light generated in the optical device;

FIG. 9 is a schematic plan view illustrating one example of an optical device according to a fourth embodiment;

FIG. 10 is a schematic cross-sectional view taken along line D-D illustrated in FIG. 9;

FIG. 11 is a diagram illustrating one example of reflected light generated in the optical device;

FIG. 12 is a schematic plan view illustrating one example of an optical device according to a fifth embodiment;

FIG. 13 is a schematic cross-sectional view taken along line E-E illustrated in FIG. 12;

FIG. 14 is a diagram illustrating one example of reflected light generated in the optical device;

FIG. 15 is a schematic plan view illustrating one example of an optical device according to a sixth embodiment;

FIG. 16 is a schematic cross-sectional view taken along line F-F illustrated in FIG. 15;

FIG. 17 is a diagram illustrating one example of reflected light generated in the optical device;

FIG. 18 is a schematic plan view illustrating one example of an optical device according to a seventh embodiment;

FIG. 19 is a schematic cross-sectional view taken along line G-G illustrated in FIG. 18;

FIG. 20 is a diagram illustrating one example of reflected light generated in the optical device;

FIG. 21 is a schematic plan view illustrating one example of an optical device according to an eighth embodiment;

FIG. 22 is a schematic cross-sectional view taken along line H-H illustrated in FIG. 21;

FIG. 23 is a diagram illustrating one example of reflected light generated in the optical device;

FIG. 24 is a diagram illustrating one example of an optical communication apparatus according to the present embodiment;

FIG. 25 a schematic plan view illustrating one example of a conventional optical device;

FIG. 26 is a schematic cross-sectional view taken along line J-J illustrated in FIG. 25;

FIG. 27 is a schematic plan view illustrating one example of a conventional optical device; and

FIG. 28 is a schematic cross-sectional view taken along line K-K illustrated in FIG. 27.

### DESCRIPTION OF EMBODIMENTS

Preferred embodiments of the present invention will be explained with reference to accompanying drawings. Furthermore, the present invention is not limited to the embodiments. In addition, each of the embodiments may be used in any appropriate combination as long as they do not conflict with each other.

### (a) First Embodiment

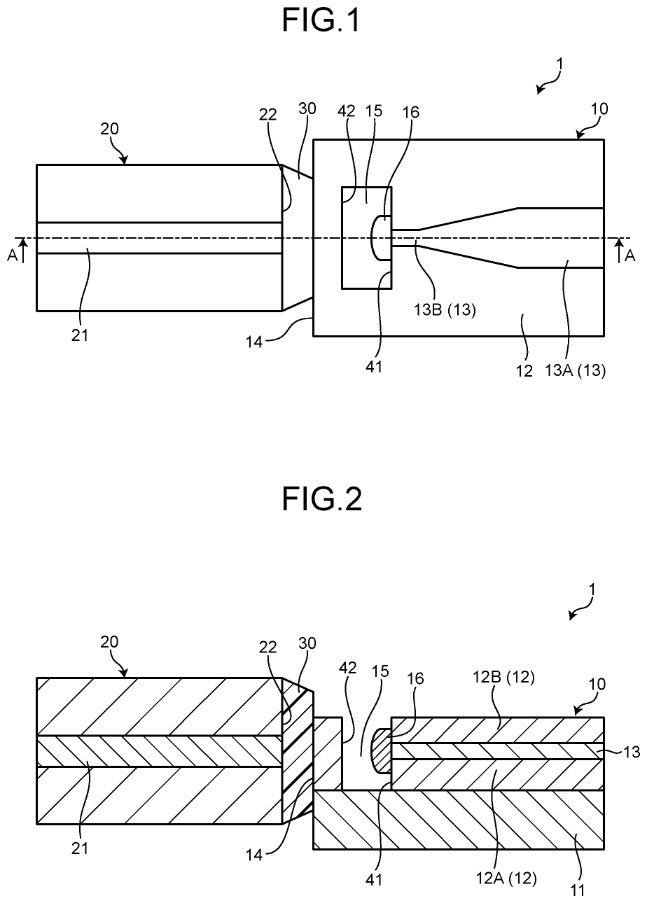

FIG. 1 is a schematic plan view illustrating one example of an optical device 1 according to a first embodiment, and FIG. 2 is a schematic cross-sectional view taken along line A-A illustrated in FIG. 1. The optical device 1 illustrated in FIG. 1 is an edge coupler that includes an optical IC chip 10 and an optical fiber 20, and in which the optical fiber 20 is mounted on the optical IC chip 10 by suing an adhesive 30.

The optical IC chip 10 includes a Si substrate 11, a first clad layer 12A that is made of SiO₂ and that is laminated on the Si substrate 11, and a Si waveguide 13 that is laminated on the first clad layer 12A. The optical IC chip 10 includes a second clad layer 12B that is made of SiO₂ and that is laminated on the Si waveguide 13 and the first clad layer 12A. The first clad layer 12A and the second clad layer 12B constitute a clad layer 12. The Si waveguide 13 includes a straight line waveguide 13A and a tapered waveguide 13B. The straight line waveguide 13A is an optical waveguide having a shape of a straight line. The tapered waveguide 13B is an optical waveguide having a tapered shape that is constituted such that the waveguide width of the tapered waveguide 13B is gradually narrower from the straight line waveguide 13A toward a chip end surface 14 viewed from the top.

The optical IC chip 10 includes a trench 15 that is formed on the Si substrate 11, a first side surface 41 of the trench 15, and a lens 16 that is arranged inside the trench 15 and that is formed on the end surface of the Si waveguide 13. The trench 15 is formed by a trench that passes through the first clad layer 12A and the second clad layer 12B in a direction from the top surface to the bottom surface of the layers. The trench 15 includes the first side surface 41 that is connected to an end surface of the Si waveguide 13, and a second side surface 42 that is located opposite the first side surface 41. The lens 16 is formed by applying a photo sensitive resist on the end surface of the Si waveguide 13 that is located on the first side surface 41 included in the trench 15. The optical fiber 20 includes a core 21, and is constituted such that the leading end of the optical fiber 20 is used as a bonding surface 22.

The optical IC chip 10 includes a chip end surface 14 that is located adjacent to the second side surface 42 that is located opposite the first side surface 41 of the trench 15. The chip end surface 14 that is located adjacent to the second side surface 42 is a bonding surface to which a core 21 of the optical fiber 20 is bonded by the adhesive 30.

When the optical fiber 20 is mounted on the optical IC chip 10, the adhesive 30 is applied on the chip end surface 14 of the optical IC chip 10, and the adhesive 30 is hardened by ensuring alignment between the core 21 of the optical fiber 20 and the Si waveguide 13. As a result of this, the optical fiber 20 is secured to the optical IC chip 10 by using the adhesive 30.

The optical device 1 according to the first embodiment includes the trench 15 that is formed on the Si substrate 11, the Si waveguide 13 that is formed on the Si substrate 11 and that is connected to the first side surface 41 of the trench 15, and the lens 16 that is arranged inside the trench 15 and that is formed at the end surface of the Si waveguide 13. Furthermore, the optical device 1 is constituted to have a structure in which the optical fiber 20 is secured, by the adhesive 30, to the chip end surface 14 that is located adjacent to the second side surface 42 that is located opposite the first side surface 41 included in the trench 15. As a result of this, it is possible to implement both of optical coupling performed by the lens 16 and fixation of the optical fiber 20 and the optical IC chip 10 performed by using the adhesive 30, so that it is possible to suppress a coupling loss occurring between the optical fiber 20 and the Si waveguide 13 while reducing the number of man-hours needed for a mounting process.

In addition, a case has been described as an example in which the bottom surface of the trench 15 included in the optical device 1 according to the first embodiment is constituted by the surface of the Si substrate 11, but the mode of light spreads inside the trench 15 and the coupling loss consequently increases caused by absorption of light by the Si substrate 11. Accordingly, an embodiment of solving this circumstance will be described below as a second embodiment.

### (b) Second Embodiment

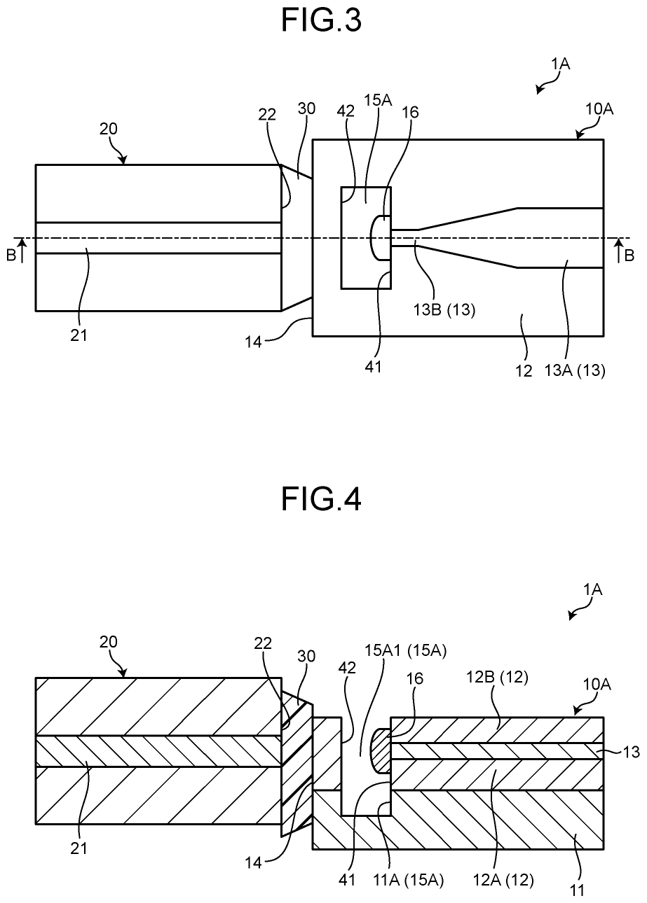

FIG. 3 is a schematic plan view illustrating one example of an optical device 1A according to the second embodiment, and FIG. 4 is a schematic cross-sectional view taken along line B-B illustrated in FIG. 3. Moreover, by assigning the same reference numerals to components having the same configuration as those in the optical device 1 according to the first embodiment, overlapped descriptions of the configuration and the operation thereof will be omitted. The optical device 1A according to the second embodiment is different from the optical device 1 according to the first embodiment in that, instead of constituting the trench 15 having a hole with a bottom surface that is formed by using the top surface of the Si substrate 11, the depth of a trench 15A is increased by also forming a second trench 11A on the top surface of the Si substrate 11.

The trench 15A includes a first trench 15A1 that passes through the first clad layer 12A and the second clad layer 12B in a direction from the top surface to the bottom surface of the layers, and the second trench 11A that is formed on the top surface of the Si substrate 11 and that communicates with the first trench 15A1. The trench 15A is formed to have a depth that is deeper than that of the trench 15 illustrated in FIG. 2.

The optical IC chip 10A is constituted to have a structure that includes the trench 15A in which the first trench 15A1 that is formed inside the clad layer 12 communicates with the second trench 11A that is formed in the Si substrate 11.

In the optical device 1A according to the second embodiment, the second trench 11A has been arranged inside the trench 15A on the Si substrate 11, so that the mode of light is not absorbed by the Si substrate 11, and thus, the coupling loss can be reduced.

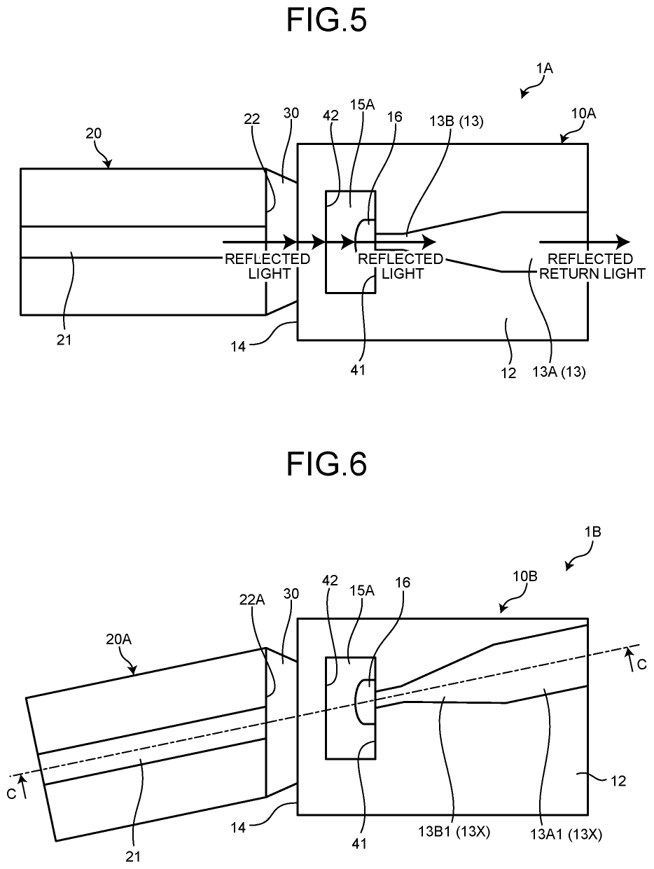

FIG. 5 is a diagram illustrating one example of reflected light generated in the optical device 1A. In the optical device 1A, the core 21 of the optical fiber 20 and the Si waveguide 13 ensure linearly alignment. Moreover, between the optical fiber 20 and the Si waveguide 13, a bonding surface 22, the adhesive 30, the chip end surface 14, the second side surface 42, the trench 15A, the lens 16, and the first side surface 41 are arranged. It is assumed a case in which light passes from the Si waveguide 13 to the optical fiber 20. The light is incident into the core 21 of the optical fiber 20 passing through the Si waveguide 13, the first side surface 41, the lens 16, the trench 15, the second side surface 42, the chip end surface 14, the adhesive 30, and the bonding surface 22.

However, it is conceivable that reflected light with respect to the travelling light is generated, for example, between the bonding surface 22 and the adhesive 30, between the adhesive 30 and the chip end surface 14, and among the second side surface 42, the lens 16, and the first side surface 41, and the optical loss increases as a result of the reflected light returning to the Si waveguide 13. Accordingly, an embodiment that is able to suppress the influence of this type of reflected light will be described below as a third embodiment.

### (c) Third Embodiment

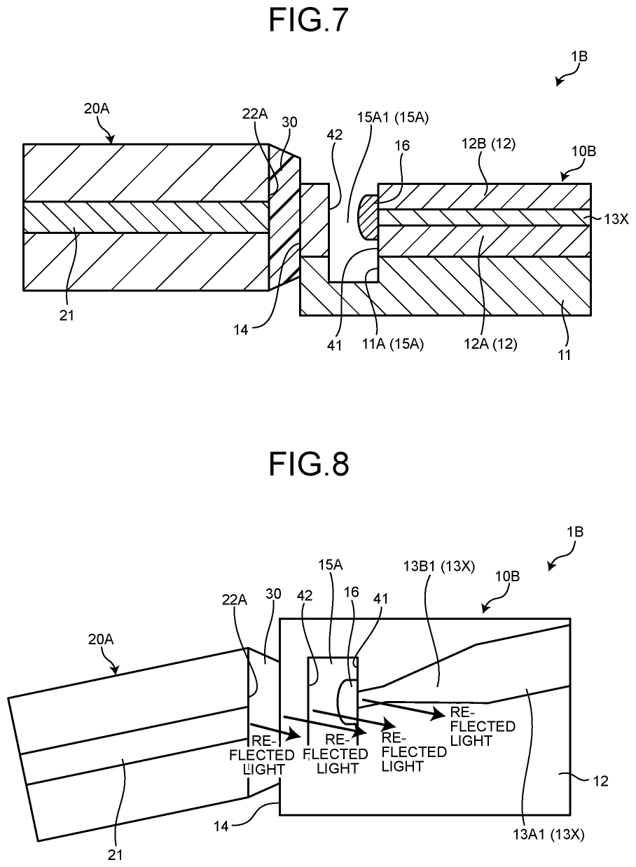

FIG. 6 is a schematic plan view illustrating one example of an optical device 1B according to the third embodiment, and FIG. 7 is a schematic cross-sectional view taken along line C-C illustrated in FIG. 6. Moreover, by assigning the same reference numerals to components having the same configuration as those in the optical device 1A according to the second embodiment, overlapped descriptions of the configuration and the operation thereof will be omitted. The optical device 1B according to the third embodiment is different from the optical device 1A according to the second embodiment in that, instead of arranging the Si waveguide 13 at the position orthogonal to the first side surface 41 of the trench 15A, a Si waveguide 13X is arranged at a position inclined with respect to the first side surface 41 of the trench 15A. Furthermore, an optical fiber 20A that is mounted on an optical IC chip 10B is constituted to have a structure in which the core 21 is arranged at a position inclined with respect to the chip end surface 14 by using the adhesive 30. The Si waveguide 13X includes a straight line waveguide 13A1 and a tapered waveguide 13B1. The straight line waveguide 13A1 is an optical waveguide having a shape of a straight line. The tapered waveguide 13B1 is an optical waveguide having a tapered shape that is constituted such that the waveguide width of the tapered waveguide 13B1 is gradually narrower from the straight line waveguide 13A1 toward a chip end surface 14 viewed from the top.

FIG. 8 is a diagram illustrating one example of reflected light generated in the optical device 1B. In the optical device 1B, the core 21 of the optical fiber 20A and the Si waveguide 13X ensure linearly alignment. Moreover, between the optical fiber 20A and the Si waveguide 13X, a bonding surface 22A, the adhesive 30, the chip end surface 14, the second side surface 42, the trench 15A, the lens 16, and the first side surface 41 are arranged. It is assumed a case in which light passes from the Si waveguide 13X to the optical fiber 20A. The light is incident into the core 21 of the optical fiber 20A passing through the Si waveguide 13X, the first side surface 41, the lens 16, the trench 15A, the second side surface 42, the chip end surface 14, the adhesive 30, and the bonding surface 22A.

The optical device 1B according to the third embodiment is constituted to have a structure in which the Si waveguide 13X is arrange at a position inclined with respect to the first side surface 41 of the trench 15A, and also, the optical fiber 20A is arranged at a position inclined with respect to the chip end surface 14. Even if reflected light with respect to the travelling light is generated between the bonding surface 22A and the adhesive 30, between the adhesive 30 and the chip end surface 14, and among the second side surface 42, the lens 16, and the first side surface 41, it is possible to avoid the situation in which the reflected light affects the light passing through the Si waveguide 13X.

In the optical device 1B according to the third embodiment, a case has been described as an example in which the optical fiber 20A is arranged at a position inclined with respect to the chip end surface 14. However, in the optical device 1B, the optical fiber 20A is mounted so as to be inclined with respect to the optical IC chip 10B, so that the area in which the optical fiber 20A is mounted with respect to the chip end surface 14 is increased. Accordingly, an embodiment that is able to suppress a mount area will be described below as a fourth embodiment.

### (d) Fourth Embodiment

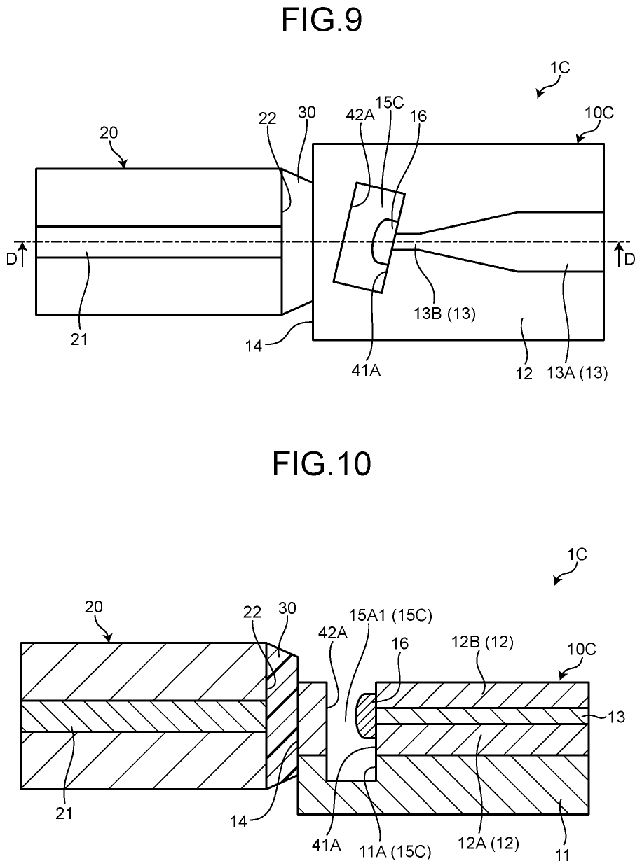

FIG. 9 is a schematic plan view illustrating one example of an optical device 1C according to the fourth embodiment, and FIG. 10 is a schematic cross-sectional view taken along line D-D illustrated in FIG. 9. Moreover, by assigning the same reference numerals to components having the same configuration as those in the optical device 1A according to the second embodiment, overlapped descriptions of the configuration and the operation thereof will be omitted. The optical device 1C according to the fourth embodiment is different from the optical device 1A according to the second embodiment in that a trench 15C is arranged at a position inclined with respect to the Si waveguide 13. The chip end surface 14 is mounted so as to be perpendicular to the optical fiber 20. The trench 15C in an optical IC chip 10C is constituted such that the first trench 15A1 communicates with the second trench 11A. Furthermore, the trench 15C includes a first side surface 41A and a second side surface 42A.

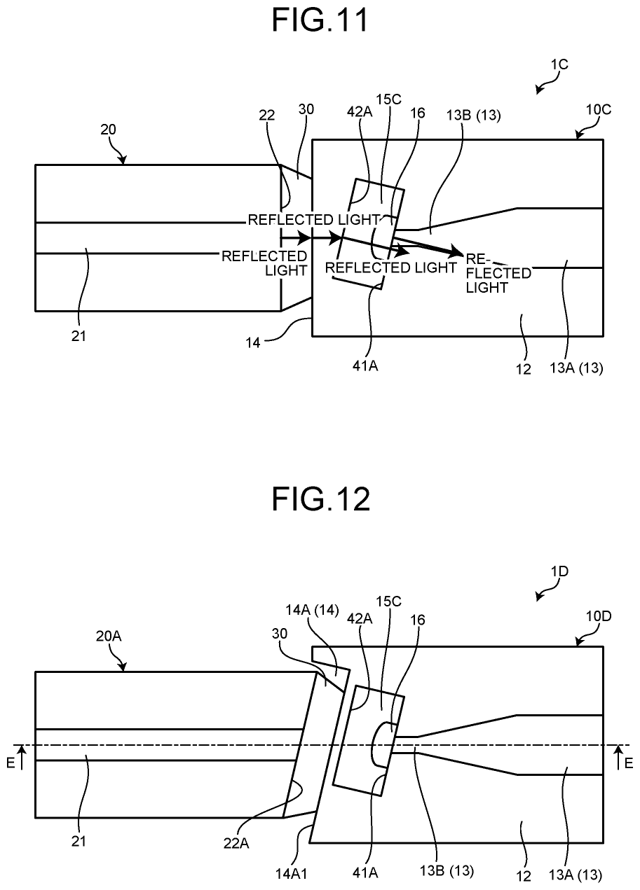

FIG. 11 is a diagram illustrating one example of reflected light generated in the optical device 1C. In the optical device 1C, the core 21 of the optical fiber 20 and the Si waveguide 13 ensure linearly alignment. Moreover, the bonding surface 22, the adhesive 30, the chip end surface 14, the second side surface 42A, the trench 15C, the lens 16, and the first side surface 41A are arranged between the optical fiber 20 and the Si waveguide 13. It is assumed a case in which light passes from the Si waveguide 13 to the optical fiber 20. The light is incident into the core 21 of the optical fiber 20 passing through the Si waveguide 13, the first side surface 41A, the lens 16, the trench 15C, the second side surface 42A, the chip end surface 14, the adhesive 30, and the bonding surface 22.

In the optical device 1C according to the fourth embodiment, the first side surface 41A and the second side surface 42A of the trench 15C are arranged so as to be inclined with respect to the Si waveguide 13. Even if reflected light with respect to the travelling light is generated among the second side surface 42A, the lens 16, and the first side surface 41A, it is possible to avoid the situation in which the reflected light affects the light passing through the Si waveguide 13.

Furthermore, the chip end surface 14 is mounted so as to be perpendicular to the optical fiber 20, so that it is possible to reduce the mount area.

Moreover, in the optical device 1C illustrated in FIG. 11, it is possible to suppress the influence of the reflected light generated among the second side surface 42A, the lens 16, and the first side surface 41A that are included in the trench 15C. However, it is difficult to suppress the influence of the reflected light that is generated between the bonding surface 22 and the adhesive 30 and between the adhesive 30 and the chip end surface 14. Accordingly, an embodiment of solving this circumstance will be described below as a fifth embodiment.

### (e) Fifth Embodiment

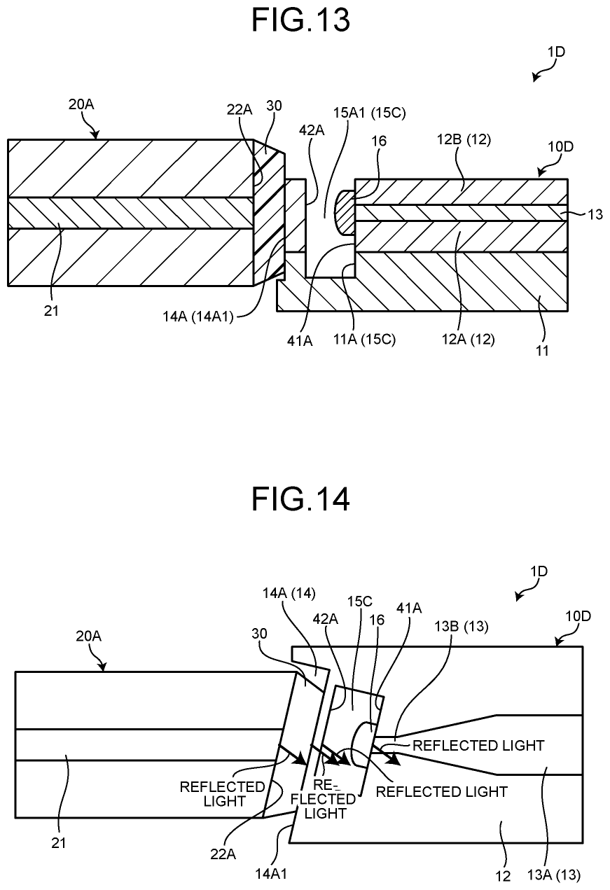

FIG. 12 is a schematic plan view illustrating one example of an optical device 1D according to the fifth embodiment, and FIG. 13 is a schematic cross-sectional view taken along line E-E illustrated in FIG. 12. Moreover, by assigning the same reference numerals to components having the same configuration as those in the optical device 1C according to the fourth embodiment, overlapped descriptions of the configuration and the operation thereof will be omitted. On the chip end surface 14 of an optical IC chip 10D included in the optical device 1D according to the fifth embodiment, a mount trench 14A that is arranged so as to be inclined with respect to the Si waveguide 13 and that has an inclined surface 14A1 that is bonded to the bonding surface 22A of the optical fiber 20A is formed.

The optical fiber 20 is constituted to have a structure in which, in order to ensure alignment between the core 21 and the Si waveguide 13 when the optical fiber 20 is bonded to the optical IC chip 10D, the bonding surface 22A that is parallel to the inclined surface 14A1 of the mount trench 14A located on the chip end surface 14 is arranged so as to be inclined. Then, the trench 15C included in the optical IC chip 10D and the mount trench 14A are arranged in parallel.

In the optical device 1D, the optical fiber 20A is mounted on the optical IC chip 10D by bonding the bonding surface 22A of the optical fiber 20A to the inclined surface 14A1 included in the mount trench 14A of the optical IC chip 10D by using the adhesive 30.

FIG. 14 is a diagram illustrating one example of reflected light generated in the optical device 1D. In the optical device 1D, the core 21 of the optical fiber 20A and the Si waveguide 13 ensure linearly alignment. Moreover, the bonding surface 22A, the adhesive 30, the inclined surface 14A1 of the chip end surface 14, the second side surface 42A, the trench 15C, the lens 16, and the first side surface 41A are arranged between the optical fiber 20A and the Si waveguide 13. It is assumed a case in which light passes from the Si waveguide 13 to the optical fiber 20A. The light is incident into the core 21 of the optical fiber 20A passing through the Si waveguide 13, the first side surface 41A, the lens 16, the trench 15C, the second side surface 42A, the inclined surface 14A1, the adhesive 30, and the bonding surface 22A.

The optical device 1D according to the fifth embodiment is constituted to have a structure in which the trench 15C and the mount trench 14A are arranged so as to be inclined with respect to the Si waveguide 13. Even if reflected light with respect to the travelling light is generated between the bonding surface 22A and the adhesive 30, between the adhesive 30 and the inclined surface 14A1, and among the second side surface 42A, the lens 16, and the first side surface 41A, it is possible to avoid the situation in which the reflected light affects the light passing through the Si waveguide 13.

Moreover, a case has been described as an example in which the trench 15C included in the optical IC chip 10D and the mount trench 14A that are illustrated in FIG. 12 are arranged in parallel. However, the trench 15C and the mount trench 14A need not be arranged in parallel as long as alignment between the core 21 of the optical fiber 20A and the Si waveguide 13 is ensured, and appropriate modifications are possible. The interior portion of the trench 15C is air (refractive index 1), whereas the mount trench 14A is filled with the adhesive 30 (refractive index 1.4 to 1.5), so that it is possible to appropriately set the angle of the trench 15C in accordance with the refractive index. Furthermore, it is also possible to adjust an arrangement angle of the trench 15C to obtain desired reflection suppression in accordance with each of a difference in width of the trench 15C a difference in mode field of light, and appropriate modifications are possible.

In the optical device 1D according to the fifth embodiment, a case has been described as an example in which the structure is constituted by the inclined surface 14A1 such that the bonding surface 22A of the optical fiber 20A is parallel to the mount surface of the mount trench 14A of the optical IC chip 10D. However, there is a need to perform a processing operation for forming the bonding surface 22A of the optical fiber 20A that is bonded to the inclined surface 14A1. In addition, for example, in the case where a two-core or three-core fiber array is used, the operation load is increased. Accordingly, an embodiment of solving this circumstance will be described below as a sixth embodiment.

### (f) Sixth Embodiment

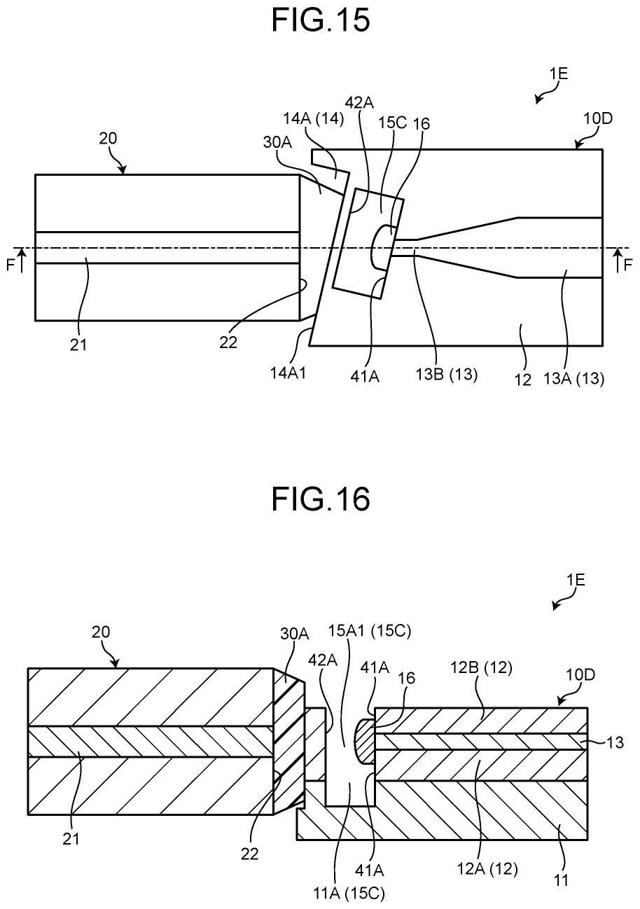

FIG. 15 is a schematic plan view illustrating one example of an optical device 1E according to the sixth embodiment, and FIG. 16 is a schematic cross-sectional view taken along line F-F illustrated in FIG. 15. Moreover, by assigning the same reference numerals to components having the same configuration as those in the optical device 1D according to the fifth embodiment, overlapped descriptions of the configuration and the operation thereof will be omitted. The optical device 1E according to the sixth embodiment is that there is no need to process the bonding surface 22 of the optical fiber 20 in order to obtain an inclined surface, and is constituted to have a structure in which a portion between the bonding surface 22 of the optical fiber 20 and the inclined surface 14A1 of the mount trench 14A is bonded by an adhesive 30A by adjusting the alignment between the optical fiber 20 and the Si waveguide 13. The thickness of the adhesive 30A between the bonding surface 22 and the inclined surface 14A1 varies in accordance with the inclined surface 14A1 viewed from top of the optical device 1E.

The optical device 1E is constituted to have a structure in which the bonding surface 22 of the optical fiber 20 and the inclined surface 14A1 of the mount trench 14A are adhered by the adhesive 30A while ensuring the alignment between the core 21 of the optical fiber 20 and the Si waveguide 13. As a result of this, there is no need to process the bonding surface 22 of the optical fiber 20, and, in addition, it is also possible to implement the bonding surface 22 of the optical fiber 20 on the inclined surface 14A1 of the mount trench 14A even in a case of using a fiber array.

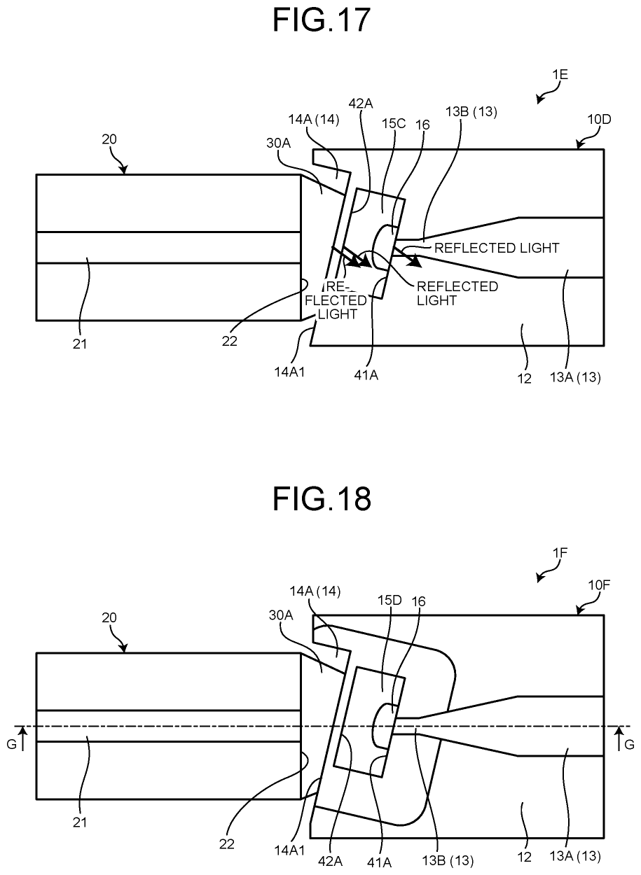

FIG. 17 is a diagram illustrating one example of reflected light that is generated in the optical device 1E. In the optical device 1E, the core 21 of the optical fiber 20 and the Si waveguide 13 ensure linearly alignment. Moreover, the bonding surface 22, the adhesive 30A, the inclined surface 14A1 of the chip end surface 14, the second side surface 42A, the trench 15C, the lens 16, and the first side surface 41A are arranged between the optical fiber 20 and the Si waveguide 13. It is assumed a case in which light passes from the Si waveguide 13 to the optical fiber 20. The light is incident into the core 21 of the optical fiber 20 passing through the Si waveguide 13, the first side surface 41A, the lens 16, the trench 15C, the second side surface 42A, the inclined surface 14A1, the adhesive 30A, and the bonding surface 22.

The optical device 1E according to the sixth embodiment is constituted to have a structure in which the trench 15C and the mount trench 14A is arranged so as to be inclined with respect to the Si waveguide 13. Even if reflected light with respect to the travelling light is generated between the adhesive 30A and the inclined surface 14A1, and among the second side surface 42A, the lens 16, and the first side surface 41A, it is possible to avoid the situation in which the reflected light affects the light passing through the Si waveguide 13.

However, in the optical device 1E according to the sixth embodiment, some of light that is emitted from the Si waveguide 13 and dispersed by the lens 16 is absorbed by the Si substrate 11, so that there may be a situation in which the optical loss increases. Accordingly, an embodiment of solving this circumstance will be described below as a seventh embodiment.

### (g) Seventh Embodiment

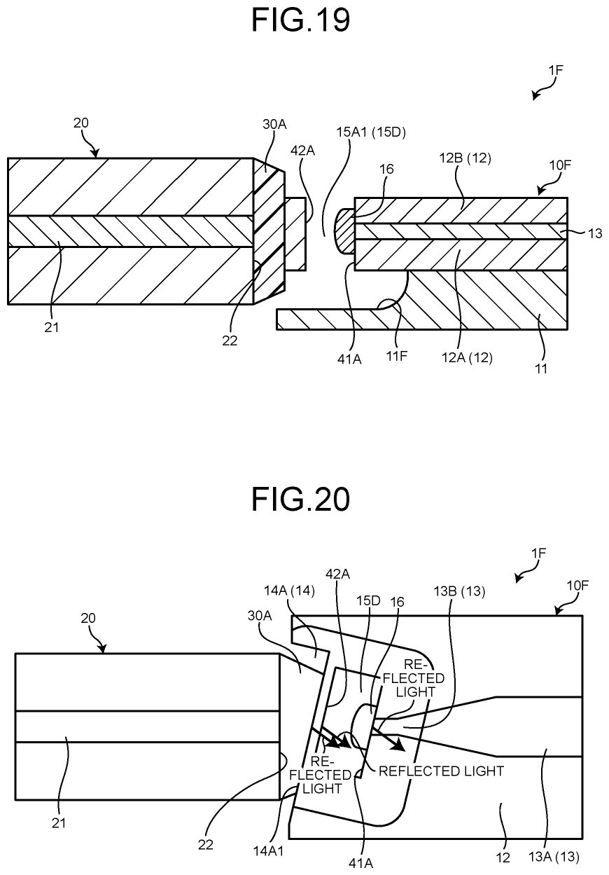

FIG. 18 is a schematic plan view illustrating one example of an optical device 1F according to the seventh embodiment, and FIG. 19 is a schematic cross-sectional view taken along line G-G illustrated in FIG. 18. Moreover, by assigning the same reference numerals to components having the same configuration as those in the optical device 1E according to the sixth embodiment, overlapped descriptions of the configuration and the operation thereof will be omitted. The optical device 1F according to the seventh embodiment is different from the optical device 1E according to the sixth embodiment in that a substrate-side trench 11F is formed on an optical IC chip 10F by notching the bottom surface of a trench 15D and a part of the Si substrate 11 that is located at the lower part of the first side surface 41A and the second side surface 42A. The opening area of the substrate-side trench 11F is formed to have a larger opening area than that of the trench 15D that is formed in the clad layer 12.

FIG. 20 is a diagram illustrating one example of reflected light that is generated in the optical device 1F. In the optical device 1F, the core 21 of the optical fiber 20 and the Si waveguide 13 ensure linearly alignment. Moreover, the bonding surface 22, the adhesive 30A, the inclined surface 14A1 of the chip end surface 14, the second side surface 42A, the trench 15D, the lens 16, and the first side surface 41A are arranged between the optical fiber 20 and the Si waveguide 13. It is assumed a case in which light passes from the Si waveguide 13 to the optical fiber 20. The light is incident into the core 21 of the optical fiber 20 passing through the Si waveguide 13, the first side surface 41A, the lens 16, the trench 15D, the second side surface 42A, the inclined surface 14A1, the adhesive 30A, and the bonding surface 22.

The optical device 1F according to the seventh embodiment is constituted to have a structure in which the trench 15D and the mount trench 14A are arranged so as to be inclined with respect to the Si waveguide 13. Even if reflected light with respect to the travelling light is generated between the adhesive 30A and the inclined surface 14A1, and among the second side surface 42A, the lens 16, and the first side surface 41A, it is possible to avoid the situation in which the reflected light affects the light passing through the Si waveguide 13.

In the optical device 1F according to the seventh embodiment, the substrate-side trench 11F is formed on the optical IC chip 10F by notching the bottom surface of the trench 15D and a part of the Si substrate 11 that is located at the lower part of the first side surface 41A and the second side surface 42A. As a result of this, it is possible to reduce the optical loss by restraining light that is emitted from the Si waveguide 13 and dispersed by the lens 16 from being absorbed at the Si substrate 11.

In addition, in the optical device 1F according to the seventh embodiment, the clad layer 12 that is made of SiO₂ is located between the trench 15D and the adhesive 30A, but, if the refractive index of the adhesive 30A is low, there may be a situation in which reflected light affects a portion between the adhesive 30A and the clad layer 12 that is made of SiO₂. Accordingly, an embodiment of solving this circumstance will be described below as an eighth embodiment.

### (h) Eighth Embodiment

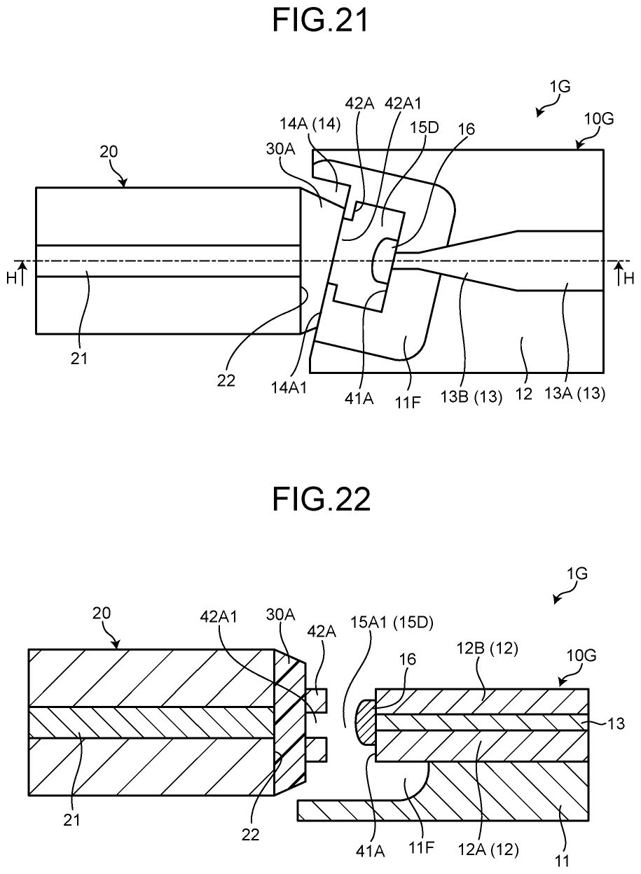

FIG. 21 is a schematic plan view illustrating one example of an optical device 1G according to the eighth embodiment, and FIG. 22 is a schematic cross-sectional view taken along line H-H illustrated in FIG. 21. Moreover, by assigning the same reference numerals to components having the same configuration as those in the optical device 1F according to the seventh embodiment, overlapped descriptions of the configuration and the operation thereof will be omitted. The optical device 1G according to the eighth embodiment is different from the optical device 1F according to the seventh embodiment in that a notch portion 42A1 that notches the clad layer 12 corresponding to a part of the second side surface 42A that is included in the trench 15D and that is located opposite the lens 16 that is arranged on the first side surface 41A and that is included in the trench 15D of an optical IC chip 10G is formed. The notch portion 42A1 is located on the optical path between the Si waveguide 13 and the core 21 of the optical fiber 20.

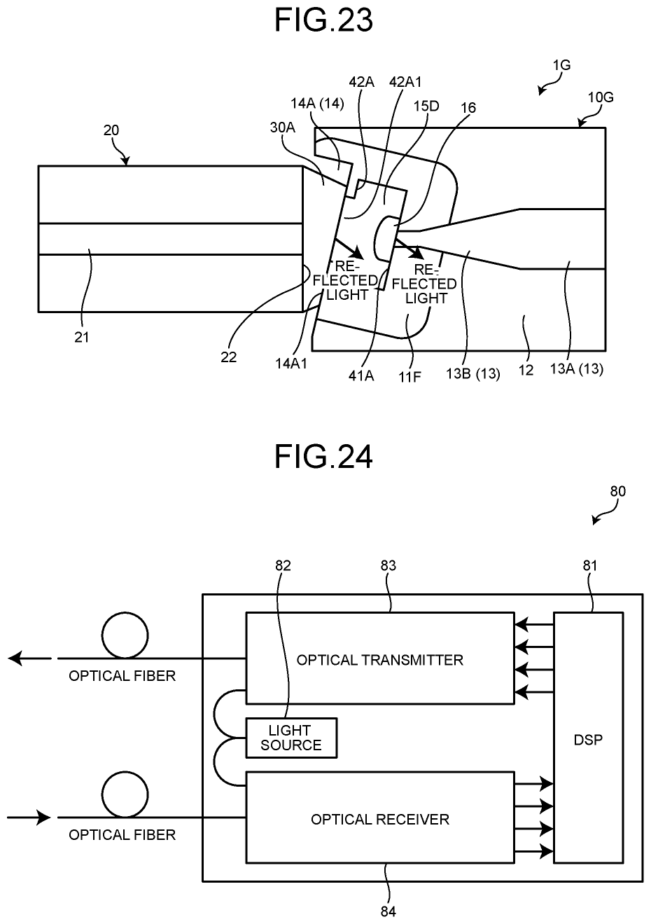

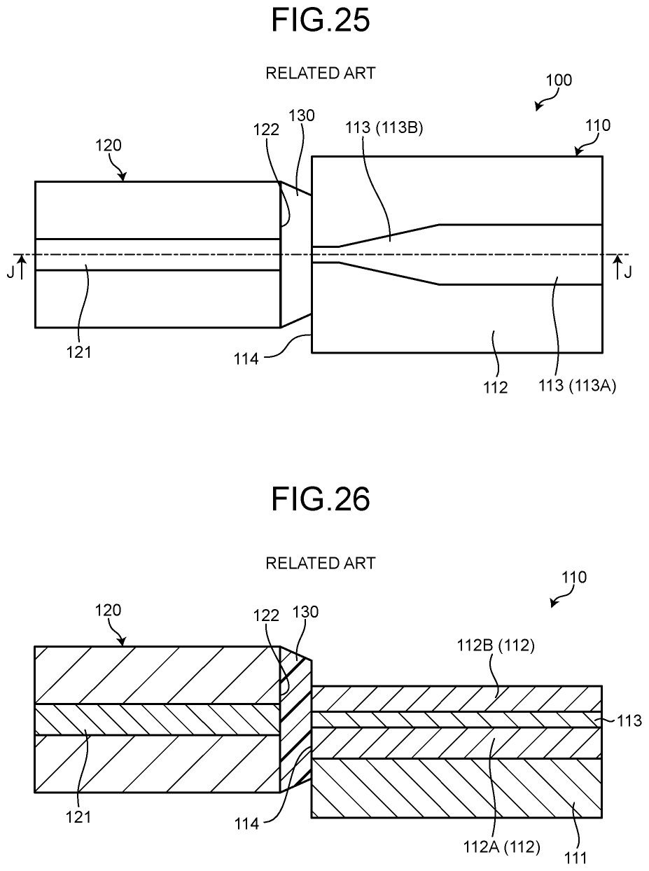

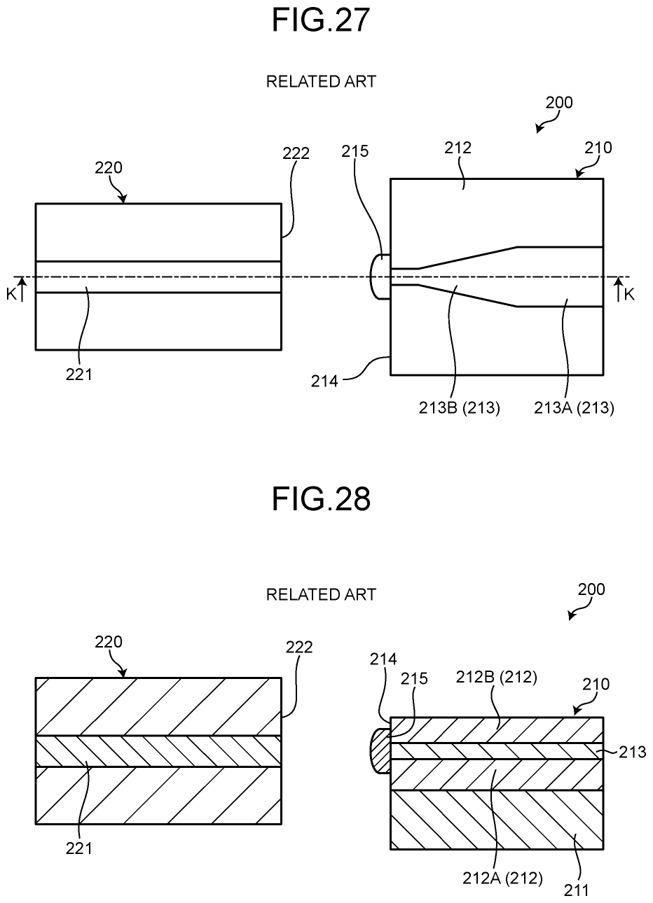

FIG. 23 is a diagram illustrating one example of reflected light generated in the optical device 1G. In the optical device 1G, the core 21 of the optical fiber 20 and the Si waveguide 13 ensure linearly alignment. Moreover, the adhesive 30A, the inclined surface 14A1 of the chip end surface 14, the notch portion 42A1 included in the second side surface 42A, the trench 15D, the lens 16, and the first side surface 41A are arranged between the optical fiber 20 and the Si waveguide 13, the bonding surface 22. It is assumed a case in which light passes from the Si waveguide 13 to the optical fiber 20. The light is incident into the core 21 of the optical fiber 20 passing through the Si waveguide 13, the first side surface 41A, the lens 16, the trench 15D, the notch portion 42A1 included in the second side surface 42A, the inclined surface 14A1, the adhesive 30A, and the bonding surface 22.

The optical device 1G according to the eighth embodiment is constituted to have a structure in which the trench 15D and the mount trench 14A are arranged so as to be inclined with respect to the Si waveguide 13. Even if reflected light with respect to the travelling light is generated between the adhesive 30A and the notch portion 42A1 and between the lens 16 and the first side surface 41A, it is possible to avoid the situation in which the reflected light affects the light passing through the Si waveguide 13.

In the optical device 1G according to the eighth embodiment, the notch portion 42A1 that notches the clad layer 12 corresponding a part of the second side surface 42A and that is included in the trench 15D that is located opposite the lens 16 that is arranged on the first side surface 41A and that is included in the trench 15D is formed. As a result of this, SiO₂ is not present between the trench 15D and the adhesive 30A on the optical path at the notch portion 42A1, so that light is not reflected between the adhesive 30A and SiO₂ of the clad layer 12, it is possible to suppress reflected return light.

In addition, in the optical devices 1, and 1A to 1G according to the respective first to the eighth embodiments, a case has been described as an example in which the structure is constituted by an edge coupler in which the core 21 of the optical fiber 20 is optically coupled to the Si waveguide 13, but the example is not limited to the Si waveguide 13. Instead of this, a SiN waveguide may be used, and appropriate modifications are possible.

An optical communication apparatus 80 that includes, as built-in units, the optical devices 1 and 1A to 1G according to the respective first to the eighth embodiments will be described. FIG. 24 is a diagram illustrating one example of the optical communication apparatus 80 that includes, as a built-in unit, one of the optical devices 1 and 1A to 1G according to the present embodiment. The optical communication apparatus 80 illustrated in FIG. 24 is connected to an optical fiber that is disposed on an output side and an optical fiber that is disposed on an input side. The optical communication apparatus 80 includes a digital signal processor (DSP) 81, a light source 82, an optical transmitter 83, and an optical receiver 84. The DSP 81 is an electrical component that performs digital signal processing. The DSP 81 performs a process of, for example, encoding transmission data or the like, generating an electrical signal including transmission data, and outputs the generated electrical signal to the optical transmitter 83. Furthermore, the DSP 81 acquires an electrical signal including reception data from the optical receiver 84 and obtains reception data by performing a process of, for example, decoding the acquired electrical signal.

The light source 82 is, for example, an integrated tunable laser assembly (ITLA) that includes, for example, a laser diode or the like, generates light with a predetermined wavelength, and supplies the generated light to the optical transmitter 83 and the optical receiver 84. The optical transmitter 83 is an optical modulator that modulates, by using the electrical signal output from the DSP 81, the light supplied from the light source 82, and outputs the obtained transmission light to the optical fiber. The optical transmitter 83 generates the transmission light by modulating, when the light supplied from the light source 82 propagates through the waveguide, the light by using the electrical signal that is input to the optical modulator. The optical transmitter 83 includes, as a built-in unit, an edge coupler corresponding to one of the optical devices 1 and 1A to 1G according to the present embodiment at a position connected to the optical fiber.

The optical receiver 84 receives the optical signal from the optical fiber, and demodulates the received light by using the light that is supplied from the light source 82. Then, the optical receiver 84 converts the demodulated received light to an electrical signal and outputs the converted electrical signal to the DSP 81. The optical receiver 84 includes, as a built-in unit, one of the corresponding optical devices 1 and 1A to 1G according to the present embodiment at a position connected to the optical fiber.

In addition, for convenience of description, a case has been described as an example in which the optical communication apparatus 80 includes, as built-in units, both of the optical transmitter 83 and the optical receiver 84, but one of the optical transmitter 83 and the optical receiver 84 may be included as a built-in unit. For example, in a case in which only the optical transmitter 83 is built in, the optical transmitter 83 functions as an optical transmission device, whereas, in a case in which only the optical receiver 84 is built in, the optical receiver 84 functions as an optical reception device.

According to an aspect of an embodiment, it is possible to suppress a coupling loss between the optical waveguide and the optical fiber while reducing the number of man-hours needed for a mounting process.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An optical device comprising:
a substrate;
a trench that is formed on the substrate;
an optical waveguide that is formed on the substrate and that is connected to a first side surface of the trench;
a lens that is arranged on the first side surface included in the trench and that is connected to the optical waveguide; and
an optical fiber that is secured, by an adhesive, to a chip end surface that is located adjacent to a second side surface that is located opposite the first side surface included in the trench.

2. The optical device according to claim 1, wherein
the chip end surface includes
a first clad layer that is formed on the substrate, and
a second clad layer that is formed on the first clad layer, and
the trench is formed by a trench that passes through the first clad layer and the second clad layer.

3. The optical device according to claim 1, wherein
the chip end surface includes
a first clad layer that is formed on the substrate, and
a second clad layer that is formed on the first clad layer, and
the trench includes
a first trench that passes through the first clad layer and the second clad layer, and
a second trench that is formed on the substrate located at a bottom surface of the first trench.

4. The optical device according to claim 1, wherein the optical waveguide is formed on the substrate such that the optical waveguide is arranged so as to be inclined with respect to the first side surface.

5. The optical device according to claim 1, wherein the trench is formed on the substrate such that the trench is arranged so as to be inclined with respect to the optical waveguide.

6. The optical device according to claim 1, wherein, a mount trench that is arranged so as to be inclined with respect to the optical waveguide, and that has an inclined surface to which the optical fiber is bonded is formed on the chip end surface.

7. The optical device according to claim 6, wherein a thickness of the adhesive that bonds between the inclined surface included in the chip end surface and the optical fiber is different in accordance with the inclined surface.

8. The optical device according to claim 1, wherein the substrate includes a substrate-side trench that is formed by notching a bottom surface of the trench and notching a portion in which the first side surface and the second side surface are formed.

9. The optical device according to claim 8, wherein the second side surface includes a notch portion that is formed by notching a portion through which signal light, which passes through the optical waveguide, passes.

10. An optical transmission device comprising:
a processor that executes signal processing on an electrical signal;
a light source that generates light; and
an optical transmitter that modulates, by using the electrical signal output from the processor, the light generated from the light source, wherein
an optical device included in the optical transmitter includes
a substrate,
a trench that is formed on the substrate,
an optical waveguide that is formed on the substrate and that is connected to a first side surface of the trench,
a lens that is arranged on the first side surface included in the trench and that is connected to the optical waveguide, and
an optical fiber that is secured, by an adhesive, to a chip end surface that is located adjacent to a second side surface that is located opposite the first side surface included in the trench.

11. An optical reception device comprising:
a light source that generates light; and
an optical receiver that demodulates reception light by using the light received from the light source, wherein
an optical device included in the optical receiver includes
a substrate,
a trench that is formed on the substrate,
an optical waveguide that is formed on the substrate and that is connected to a first side surface of the trench,
a lens that is arranged on the first side surface included in the trench and that is connected to the optical waveguide, and
an optical fiber that is secured, by an adhesive, to a chip end surface that is located adjacent to a second side surface that is located opposite the first side surface included in the trench.
